(19) United States
(12) Patent Application Publication
(10) Pub. No.: US 2023/0331979 A1
(43) Pub. Date: Oct. 19, 2023

(54) FIBER REINFORCED THERMOPLASTIC MATRIX COMPOSITE MATERIAL

(71) Applicants: SOLVAY SPECIALTY POLYMERS USA, LLC, Alpharetta, GA (US); Cytec Industries Inc., Princeton, NJ (US)

(72) Inventors: Chantal Louis, Alpharetta, GA (US); Mohammad Jamal El-Hibri, Atlanta, GA (US); James Francis Pratte, Wilmington, DE (US)

(73) Assignees: SOLVAY SPECIALTY POLYMERS USA, LLC, Alpharetta, GA (US); Cytec Industries Inc., Princeton, NJ (US)

(21) Appl. No.: 18/009,678

(22) PCT Filed: Jun. 4, 2021
(86) PCT No.: PCT/EP2021/064962

§ 371 Date: Dec. 9, 2022

Related U.S. Application Data
(60) Provisional application No. 63/115,253, filed on Nov. 18, 2020.
(60) Provisional application No. 63/038,100, filed on Jun. 11, 2020.

(30) Foreign Application Priority Data
Sep. 2, 2020 (EP) 20194026.9

(51) Int. Cl. C08L 61/02; C08J 5/04; B32B 5/02; B32B 5/26; B29C 71/02; B29C 70/00

(52) U.S. Cl. CPC C08L 61/02; C08J 5/042; B32B 5/02; B32B 5/26; B29C 71/02; B29C 70/003; C08L 2205/16; C08L 2205/025; C08J 2361/02; B32B 2262/106; B32B 2260/021; B32B 2260/046; B32B 2307/542; B32B 2307/54; B29C 70/38

(57) ABSTRACT

Fiber reinforced composite material comprising a thermoplastic matrix comprising blends of poly(ether ketone ketone) (PEKK) polymers, their method of manufacture and articles obtained therefrom.

This application is a national stage entry of PCT/EP2021/064962, which claims priorities of US provisional applications 63/038,100 filed on Jun. 11, 2020, 63/115,253 filed on Nov. 18, 2020 and of EP patent application 20194026.9 filed on Sep. 2, 2020, the whole content of each of these applications being incorporated herein by reference for all purposes.

### TECHNICAL FIELD

The present invention relates to a fiber reinforced composite material comprising a thermoplastic matrix, more particularly to fiber reinforced composite materials wherein the thermoplastic matrix comprises blends of poly(ether ketone ketone) (PEKK) polymers, in particular blends having a combination of melting temperature, crystallinity and rate of crystallization which are adapted to the composite part fabrication process and/or required performance.

### BACKGROUND ART

Poly(ether ketone ketone) (“PEKK”) polymers are well established materials which have found use in relatively extreme conditions. Due to their high crystallinity and high melt temperature, PEKK polymers have excellent thermal, physical and mechanical properties. Such properties make PEKK polymers desirable in a wide range of demanding application settings including, but not limited to, aerospace and oil and gas drilling, but also as thermoplastic matrices for composite structures.

PEKK with a nominal terephthaloyl to isophthaloyl molar ratio (T/I) of about 70/30 is a well-established and proven matrix resin for thermoplastic continuous fiber composites. For instance, PEKK composites such as APC (PEKK FC)/AS4D, a carbon fiber reinforced PEKK unidirectional composite tape supplied by Solvay, are used extensively for making a variety of airplane parts using rapid fabrication processes like stamp forming and continuous compression molding. Their excellent mechanical and environmental performance combined with cost effective fabrication processes has made them relatively industry standards for numerous composite parts such as airplane brackets, clips, stiffeners, and window frames to name a few.

One limitation of using PEKK polymers as polymeric matrix in fiber reinforced composite materials is the high melt processing temperature (>370° C.) needed to easily shape, form, fuse and consolidate the material. This limitation becomes more acute as the size of the part, particularly on an areal basis, increases substantially. An example of this would be fabricating a composite wing or fuselage skin for a commercial jet liner. Today these structures are fabricated with carbon fiber reinforced epoxy composites using either automated tape laying (ATL) or automated fiber placement (AFP) machines. These machines deposit the prepreg unidirectional composite tape onto the tool per the designed lay-up, which is then then bagged and cured in an autoclave or an oven with a process known as vacuum bag only (VBO). The curing temperature of such materials is ˜175° C., which is less than half the processing temperature of PEKK composites. The higher the process temperature, the more likely it is that there will be greater temperature variation across the surface of the part. Such variation may lead to some areas being overheated and some areas not consolidated. In addition, the higher process temperature of PEKK composites limits the deposition speed with AFP and ATL equipment. Adequate deposition speed is needed to achieve economical rates, to be cost competitive with other materials such as carbon fiber epoxies and metal structures.

Other innovative part fabrication approaches, such as in-situ consolidation, where the thermoplastic composite is consolidated as it is fused to the previous layer using a specialized ATL or AFP machines, are too slow due to the large temperature gap between fusing of the matrix and cooling it while under pressure, thus limiting the implementation of such innovative approaches which have the potential to substantially save cost by removing the secondary consolidation step with an oven or autoclave. Thus, it is desirable to have a lower processing temperature PEKK polymer that maintains the structural performance of PEKK composites, which would enable more economical processing for larger composite structures.

More generally, it would be desirable to have PEKK polymer compositions that could be easily fine tuned to provide an optimization of melting temperature, crystallization level, and crystallization rate, relative to a specific part fabrication process and/or performance requirement.

### DISCLOSURE OF THE INVENTION

It has been now found that the thermal behaviour and crystallization kinetics of PEKK polymers can be modulated by blending PEKK polymers having different T/I ratios, namely a first PEKK polymer having a first T/I ratio with a second PEKK polymer having a second T/I ratio different from the T/I ratio of the first PEKK polymer

Advantageously, the two PEKK polymers having different T/I ratios also have different melting temperatures and crystallization rates and they allow achieving a blend, in a continuous fiber reinforced composite, that has a melting temperature, crystallization level and crystallization rate that are intermediate between the two PEKK polymers. The composition of the blend can be adjusted to achieve a specific melting temperature, crystallization level and rate tuned to the application and fabrication process

In certain embodiments the composite materials are processable at lower temperature than analogous fiber-reinforced PEKK composite materials. The composite materials may also have a high crystallization rate allowing rapid fabrication processes with short cycle times. The composite materials exhibit composite mechanical performance similar to those of analogous fiber-reinforced PEKK composite materials due to the high crystallization level of the PEKK composition. The composite materials combine fast fabrication cycle times with the improved economics that accompany lower energy consumption. The high level of crystallinity in these compositions ensures robust chemical resistance in the composite structures utilizing them.

### DETAILED DESCRIPTION OF THE INVENTION

The present invention provides a composite material, comprising:
fibers, and
a thermoplastic polymer matrix comprising a composition [composition (C)] comprising a first and a second PEKK polymer each PEKK polymer characterised by a T/I ratio, wherein the T/I ratio of the first PEKK polymer is different from T/I ratio of the second PEKK polymer.

The invention further provides methods for preparing the inventive composite materials as well as moulded articles comprising the same. A further object of the invention are articles obtained therefrom.

### Composition (C)

The composite material of the invention comprises a polymeric matrix comprising composition (C) comprising a first and a second PEKK polymer each PEKK polymer characterised by a T/I ratio.

Each PEKK polymer comprises recurring units (R^{T}) and recurring units (R^{I}) as defined below.

The expression “T/I ratio”, (T/I), is used to refer to the ratio between the molar content of recurring units Op and the molar content of recurring units (R^{T}) in the PEKK polymer, wherein recurring unit Op is represented by formula (T):

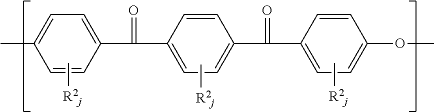

and recurring unit (R^{I}) is represented by formula (I):

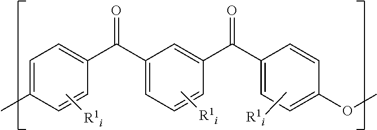

wherein:
in each of formula (T) and formula (I), each R¹ and R², at each instance, is independently selected from the group consisting of an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
each i and j, at each instance, are integers independently selected from 0 to 4.

For the avoidance of doubt, the molar content of recurring units (R^{T}), is defined as:

$$T ( mol . \% ) = \frac{[ units ( {R}^{T} ) ]}{[ units ( {R}^{T} ) ] + [ units ( {R}^{I} ) ]} \times 100 ,$$

the molar content of recurring units (R^{I}), is defined as:

$$I ( mol . \% ) = \frac{[ units ( {R}^{I} ) ]}{[ units ( {R}^{T} ) ] + [ units ( {R}^{I} ) ]} \times 100 ,$$

and the T/I ratio is hence defined as:

$$( T / I ) = \frac{T}{I} .$$

According to an embodiment, R¹ and R² are, at each location in formulas (T) and (I) above, independently selected from the group consisting of a C₁-C₁₂ moiety optionally comprising one or more than one heteroatoms; sulfonic acid and sulfonate groups; phosphonic acid and phosphonate groups; amine and quaternary ammonium groups.

According to another embodiment, i and j are zero for each R¹ and R² group. In other words, recurring units (R^{T}) and (R^{I}) are both unsubstituted. According to this embodiment, recurring units (R^{T}) and (R^{I}) are respectively represented by formulas (T′) and (I′):

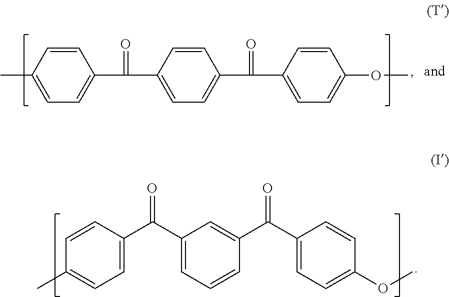

According to another embodiment, the polymers (PEKK) comprise recurring units (R^{T}) and recurring units (R^{I}), as detailed above, in a combined amount of at least 50 mol. %, based on the total number of moles in the PEKK polymer.

Each PEKK polymer may comprise minor amounts of recurring units different from recurring units (R^{T}) and recurring units (R^{I}), as detailed above, and which may be selected from the group consisting of recurring units (R_{PAEK}) comprising a Ar—C(O)—Ar′ group, with Ar and Ar′, equal to or different from each other, being aromatic groups. Recurring units (R_{PAEK}) may be generally selected from the group consisting of formulae (J-A) to (J-O), herein below:

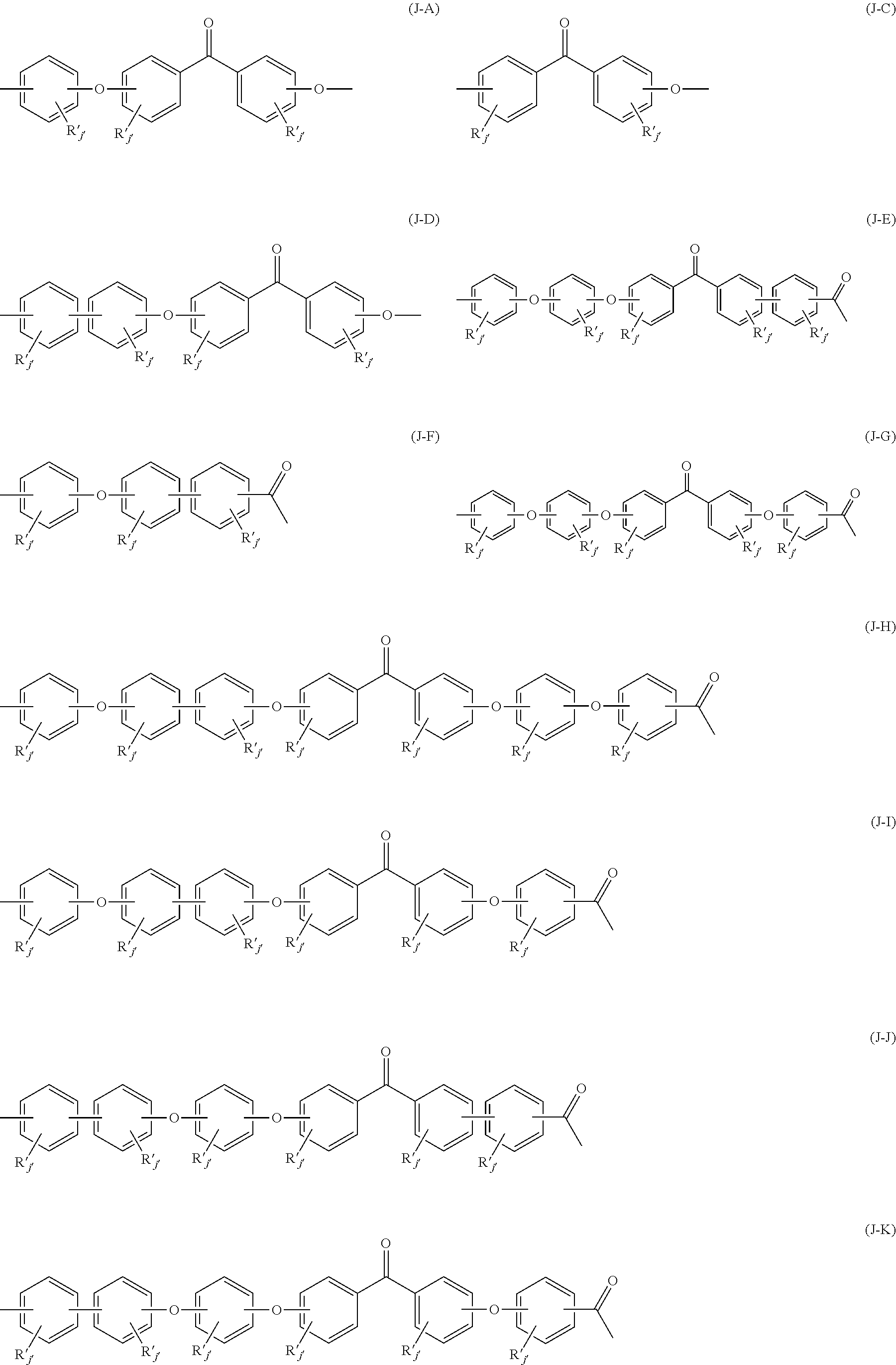

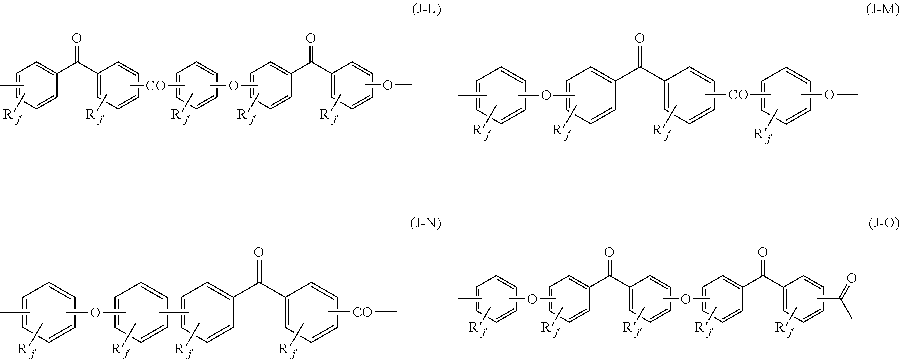

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j′ is zero or is an integer from 0 to 4.

In recurring unit (R_{PAEK}), the respective phenylene moieties may independently have 1,2-, 1,4- or 1,3-linkages to the other moieties different from R′ in the recurring unit. Preferably, said phenylene moieties have 1,3- or 1,4-linkages, more preferably they have 1,4-linkage.

Still, in recurring units (R_{PAEK}), j′ is at each occurrence zero, that is to say that the phenylene moieties have no other substituents than those enabling linkage in the main chain of the polymer.

Preferred recurring units (R_{PAEK}) are thus selected from those of formulae (J′-A) to (J′-O) herein below:

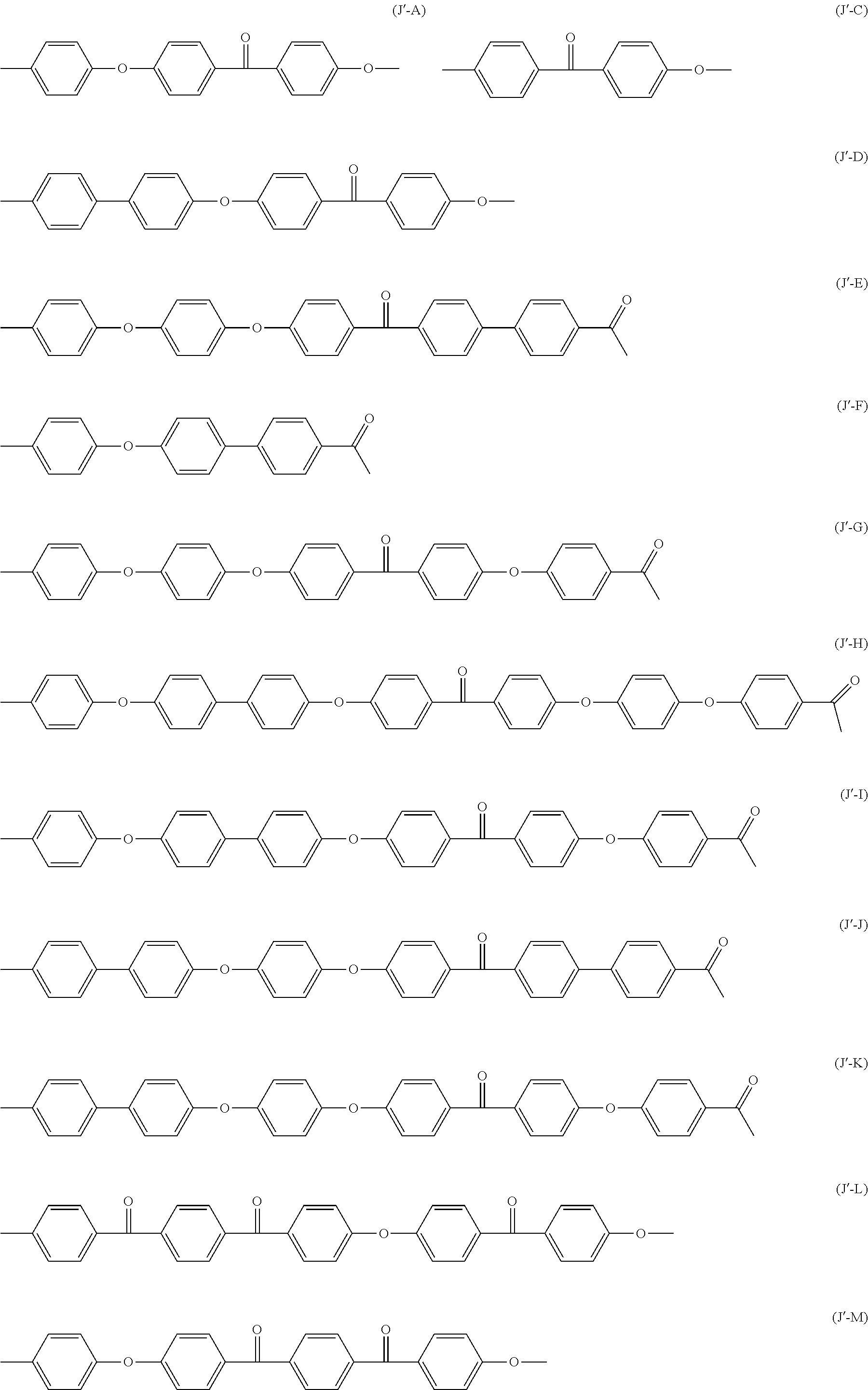

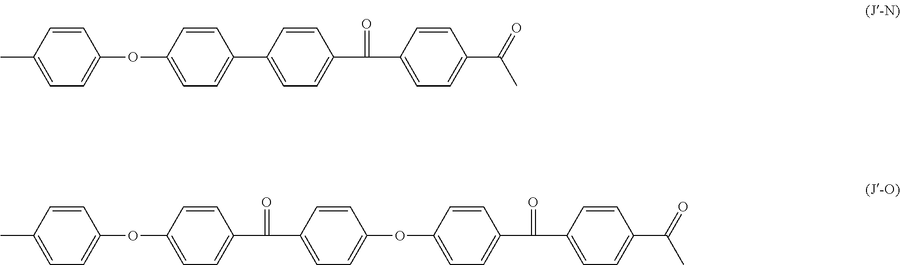

While PEKK polymers comprising recurring units (R_{PAEK}) different from recurring units (R^{T}) and (R^{I}), as detailed above, may be used, it is generally understood that preferred polymers (PEKK) are those wherein the amount of said recurring units (R_{PAEK}) is limited, and is preferably of at most 40 mol. %, more preferably at most 30 mol. %, more preferably at most 20 mol. %, even more preferably at most 10 mol. %, even at most 5 mol. %, the mol. % being based on the total number of moles in the PEKK polymer.

Hence, according to an embodiment, at least 60 mol. %, at least 70 mol. %, at least 80 mol. %, at least 90 mol. %, at least 95 mol. %, at least 99 mol. % or substantially all of the recurring units in the PEKK polymers are recurring units (R^{T}) and (R^{I}), as detailed above, the mol. % being based on the total number of moles in the PEKK polymer. The expression “substantially all”, when used in connection with constituting recurring units of PEKK polymers is intended to indicate that minor amounts of spurious/defective recurring units may be present, e.g. in an amount of less than 1 mol. %, preferably of less than 0.5 mol. %, more preferably of less than 0.1 mol. %. When no other recurring unit than recurring units Op and (R^{I}) is detected in PEKK polymer, this polymer will be qualified as a PEKK polymer wherein all units are units (R^{T}) and (R^{I}), which is a preferred embodiment of the present invention.

Composition (C) hence comprises a first PEKK polymer, hereinafter identified as polymer (PEKK_{low}) having a T/I ratio (T/I)_{low}, and a second PEKK polymer, hereinafter identified as polymer (PEKK_{high}), having T/I ratio (T/I)_{high}, such that (T/I)_{low}<(T/I)_{high}.

For the avoidance of doubt (PEKK_{low}) and (PEKK_{high}) comprise recurring units (R^{T}) and (R^{I}) and optionally (R_{PAEK}) as defined above. (PEKK_{low}) has a molar content of units (R^{T}) [(T_{low})] and a molar content of units (R^{I}) [(I_{low})], with

$${T}_{low} ( mol . \% ) = \frac{{[ units ( {R}^{T} ) ]}_{low}}{{[ units ( {R}^{T} ) ]}_{low} + {[ units ( {R}^{I} ) ]}_{low}} \times 100$$

and with

$${I}_{low} ( mol . \% ) = \frac{{[ units ( {R}^{I} ) ]}_{low}}{{[ units ( {R}^{T} ) ]}_{low} + {[ units ( {R}^{I} ) ]}_{low}} \times 100 ,$$

so defining the T/I ratio

$$[ {( T / I )}_{low} ] , with {( T / I )}_{low} = \frac{{T}_{l o w}}{{I}_{low}} .$$

Polymer (PEKK_{high}) has a molar content of units (R^{T}) [(T_{high})] and a molar content of units (R^{I}) [(I_{high})], with

$${T}_{high} ( mol . \% ) = \frac{{[ units ( {R}^{T} ) ]}_{high}}{{[ units ( {R}^{T} ) ]}_{high} + {[ units ( {R}^{I} ) ]}_{high}} \times 100$$

and with

$${I}_{high} ( mol . \% ) = \frac{{[ units ( {R}^{I} ) ]}_{high}}{{[ units ( {R}^{T} ) ]}_{high} + {[ units ( {R}^{I} ) ]}_{high}} \times 100 ,$$

so defining the T/I ratio

$$[ {( T / I )}_{high} ] , with {( T / I )}_{high} = \frac{{T}_{high}}{{I}_{high}} .$$

Polymer (PEKK_{low}) preferably has a (T/I)_{low} of at least 50/50, preferably of at least 54/46, more preferably of at least 56/44; most preferably of at least 57/43 and/or a (T/I)_{low} of at most 64/36, preferably of at most 63/37, more preferably of at most 62/38. Polymers (PEKK_{low}) with a (T/I)_{low} of comprised between 57/43 and 62/38 have been found particularly advantageous for use in the composite materials of the present invention.

Polymer (PEKK_{high}) preferably has a (T/I)_{high} of at least 65/35, preferably of at least 66/34, more preferably of at least 67/33; and/or a (T/I)_{high} of at most 85/15, preferably of at most 83/17, more preferably of at most 82/18. Polymers (PEKK_{high}) with a (T/I)_{high} of comprised between 67/33 and 72/28 have been found particularly advantageous for use in the composite materials of the present invention.

In an embodiment of the invention, in composition(C), the following inequality is satisfied: T_{high}−T_{low}≤20 mol. %. Hence, depending on the choice of a particular polymer (PEKK_{low}), possessing a certain T_{low}, the choice of the T_{high} of suitable polymers (PEKK_{high}) is consequently restricted, and vice-versa. Without being bound by this theory, the Applicant is of the opinion that when the PEKK polymers differ in fraction of T units in a moderate manner, the underlying co-crystallization phenomena which are finally responsible for the advantageous thermal properties of composition (C) can be achieved.

In a further embodiment, polymer (PEKK_{low}) and polymer (PEKK_{high}) are preferably such that T_{high}−T_{low}≤17 mol. %, more preferably such that T_{high}−T_{low}≤16 mol. %, more preferably such that T_{high}−T_{low}≤15 mol. %. It is further understood that polymer (PEKK_{low}) and polymer (PEKK_{high}) generally differ in their T content in a manner such that T_{high}−T_{low}≥3 mol. %, more preferably such that T_{high}−T_{low}≥4 mol. %, even more preferably T_{high}−T_{low}≥5 mol. %.

Compositions with advantageous properties have been notably obtained with polymer (PEKK_{low}) and polymer (PEKK_{high}) such that T_{high}−T_{low} is from about 10 to about 13 mol. %.

In an embodiment of the invention polymer (PEKK_{low}) is a nucleophilic PEKK, which means that polymer (PEKK_{low}) is produced by polycondensation of di-hydroxy and di-fluoro benzoyl-containing aromatic compounds and/or of hydroxyl-fluoro benzoyl-containing aromatic compounds.

Polymer (PEKK_{high}) is also preferably a nucleophilic PEKK, which means that also polymer (PEKK_{high}) is produced by polycondensation of di-hydroxy and di-fluoro benzoyl-containing aromatic compounds and/or of hydroxyl-fluoro benzoyl-containing aromatic compounds.

The nucleophilic character of polymer (PEKK_{low}) and/or (PEKK_{high}) is notably evidenced by the presence of fluorine, in amounts of generally exceeding 100 ppm, preferably exceeding 200 ppm, even more preferably exceeding 300 ppm. Such organically-bound fluorine is the inevitable fingerprint of the use of fluorine-containing monomers. Further evidence of the nucleophilic character of polymer (PEKK_{low}) and/or (PEKK_{high}) is provided by the substantial absence of Al residues, that is to say that the Al content is generally below 50 ppm, preferably below 25 ppm, more preferably 10 ppm. Al and F content are conveniently determined by elemental analysis, such as ICP-OES analysis for Al and Combustion-ion chromatography for fluorine.

When nucleophilic, polymer (PEKK_{low}) and/or (PEKK_{high}) is also characterized by a low volatiles content. The amount of volatiles can be determined using thermogravimetry (TGA) according to ASTM D3850 method; the temperature Td, at which a determined amount of volatile materials (e.g. 1 wt. % or 2 wt. %) leave the sample, is determined by heating progressively the sample from 30° C. to 800° C. under nitrogen using a heating rate of 10° C./min. The thermal decomposition temperature at 1 wt. % is referred to as Td(1%). In an embodiment of the invention, the polymer (PEKK_{low}) and/or (PEKK_{high}) have a Td(1%) of at least 500° C., preferably at least 505° C., more preferably at least 510° C., as measured by thermal gravimetric analysis according to ASTM D3850, heating from 30° C. to 800° C. under nitrogen using a heating rate of 10° C./min.

An advantageous combination of low melting temperature, high crystallinity and low (fast) crystallization rates can be obtained when at least polymer (PEKK_{low}) is a nucleophilic PEKK, possessing notably the advantageous features (F content, Al content, Td(1%)) mentioned above. Preferably both polymer (PEKK_{low}) and polymer (PEKK_{high}) are nucleophilic PEKK, with hence also polymer (PEKK_{high}) possessing the advantageous features (F content, Al content, Td(1%)) described above in connection with polymer (PEKK_{low}).

Without being bound by this theory, the Applicant is of the opinion that the peculiar microstructure of PEKK polymers achieved through nucleophilic synthetic route, including notably absence of “regioselectivity”-errors and/or branching phenomena, which, while rare, could nonetheless occur in electrophilic synthetic route, is such to enable achieving the peculiar advantageous thermal behavior suitable for the manufacture of composite materials.

Composition (C) may contain (PEKK_{low}) and (PEKK_{high}) in any relative proportion.

Advantageously, composition (C) comprises a major amount of polymer (PEKK_{low}) and a minor amount of polymer (PEKK_{high}). The expression “major amount” and “minor amount” have the meaning commonly understood, that is to say that the amount of polymer (PEKK_{low}) exceeds the amount of polymer (PEKK_{high}).

Generally, the weight ratio between polymer (PEKK_{low}) and polymer (PEKK_{high}) in composition (C) is advantageously of at least 60/40, preferably of at least 65/35, more preferably at least 70/30, even more preferably at least 75/25 and/or it is of at most 99/1, preferably of at most 97/3, even more preferably at most 96/4.

Composition (C) is advantageously characterized by a crystallization temperature (T_{c} in C°), determined on second DSC heat scan, higher than the crystallization temperature of a PEKK polymer having the same melting temperature (Tₘ in C°) determined on second DSC heat scan. Tₘ and T_{c} are measured by differential scanning calorimetry (DSC) as detailed hereafter.

Additionally or alternatively, composition (C) exhibits:
a melting temperature (Tₘ) of less than or equal to 330° C.;
a heat of fusion (ΔHf) exceeding 25 J/g; and
no crystallization peak upon heating, on second DSC heat scan (“cold crystallization peak”).

Additionally or alternatively, composition (C) exhibits a relation between melting temperature (Tₘ in ° C.) determined on second DSC heat scan and crystallization temperature (T_{c} in ° C.) determined on first DSC cooling scan, which satisfies the following inequality:

T_{c}≥1.3716×Tₘ−190° C.

Tₘ, T_{c}, ΔHf and the absence of cold crystallization peak are measured by differential scanning calorimetry (DSC) according to ASTM D3418-03, E1356-03, E793-06, E794-06,standard, applying heating and cooling rates of 20° C./min, with a sweep from 300° C. to 400° C.

As far as the determination of presence/absence of the cold crystallization peak, it is understood that when no exothermic peak exceeding 0.5 J/g preceding melting onset temperature is detected by DSC on second heat scan, this is representative of the absence of cold crystallization peak. Generally, in the inventive composition, substantially no exothermic peak is detected by DSC on second heat scan, which means that no detectable release of energy within the sensitivity limit of the instrument is observed.

Typically, the molecular weight of composition (C) will be adapted so as to obtain a MFI, measured according to ASTM D1238, under a piston load of 8.4 kg, as defined in the examples, at a temperature of Tₘ+30 or 40° C. in the range of 60 to 120 g/10 min.

According to certain embodiments, the total weight of polymer (PEKK_{low}) and polymer (PEKK_{high}), based on the total weight of composition (C), is advantageously equal to or above 60 wt. %, preferably equal to or above 70 wt. %; more preferably equal to or above 80 wt. %, more preferably equal to or above 85 wt. %, most preferably equal to or above 90 wt. %.

According to certain embodiments, composition (C) does not comprise any other polyaryletherketone polymer [polymer (PAEK)] beside polymer (PEKK_{low}) and polymer (PEKK_{high}). In other terms, composition (C) according to these embodiments is generally substantially free from any polymer which comprises recurring units, more than 50 mol. % of which are recurring units (R*_{PAEK}) comprising a Ar*C(O) Ar*′ group, with Ar* and Ar*′, equal to or different from each other, being aromatic groups, which is not polymer (PEKK_{low}) or polymer (PEKK_{high}). Recurring units (R*_{PAEK}) in polymer (PAEK) have the same features already described above in connection with the optional recurring units (R_{PAEK}) of PEKK polymers.

According to certain embodiments, composition (C) further comprises at least one nucleating agent. The nucleating agent may be selected from the group consisting of boron-containing compounds (e.g., boron nitride, sodium tetraborate, potassium tetraborate, calcium tetraborate, etc.), alkaline earth metal carbonates (e.g., calcium magnesium carbonate), oxides (e.g., titanium oxide, aluminum oxide, magnesium oxide, zinc oxide, antimony trioxide, etc.), silicates (e.g., talc, sodium-aluminum silicate, calcium silicate, magnesium silicate, etc.), salts of alkaline earth metals (e.g., calcium carbonate, calcium sulfate, etc.), nitrides and so forth. The nucleating agent can also be carbon based. Nucleating agents in this category includes graphite, graphene, graphitic nanoplatelets and graphene oxide. It can also be a carbon black as well as other forms of carbon.

In one advantageous embodiment the nucleating agent is selected among the group of the nitrides (NI) of an element having an electronegativity (ϵ) of from 1.3 to 2.5. Electronegativity values (ϵ) are notably listed in «Handbook of Chemistry and Physics», CRC Press, 64^{th} edition, pages B-65 to B-158.

Within the context of the present invention the expression “at least one nitride (NI)” is intended to denote one or more than one nitride (NI). Mixtures of nitrides (NI) can be advantageously used for the purposes of the invention.

Non limitative examples of nitrides (NI) of an element having an electronegativity (ϵ) of from 1.3 to 2.5 are listed notably in «Handbook of Chemistry and Physics», CRC Press, 64^{th} edition, pages B-65 to B-158. The code into brackets is the one attributed by the CRC Handbook to the concerned nitride, while c denotes the electronegativity of the element from which the nitride is derived. Accordingly, nitrides (NI) of an element having an electronegativity (c) of from 1.3 to 2.5 suitable to the purpose of the present invention are notably aluminum nitride (AlN, a45, ϵ=1.5), antimony nitride (SbN, a271, ϵ=1.9), beryllium nitride (Be₃N₂, b123, ϵ=1.5), boron nitride (BN, b203, ϵ=2.0), chromium nitride (CrN, c406, ϵ=1.6), copper nitride (Cu₃N, c615, ϵ=1.9), gallium nitride (GaN, g41, ϵ=1.6), trigermanium dinitride (Ge₃N₂, g82, ϵ=1.8), trigermanium tetranitride (Ge₃N₄, g83, ϵ=1.8), hafnium nitride (HfN, h7, ϵ=1.3), iron nitrides like Fe₄N (i151, ϵ=1.8) and Fe₂N or Fe₄N₂ (i152, ϵ=1.8), mercury nitride (Hg₃N₂, m221, ϵ=1.9), niobium nitride (n109, ϵ=1.6), silicium nitride (Si₃N₄, s109, ϵ=1.8), tantalum nitride (TaN, t7, ϵ=1.5), titanium nitride (Ti₃N₄, t249, ϵ=1.5), tungsten dinitride (WN₂, t278, ϵ=1.7), vanadium nitride (VN, v15, ϵ=1.6), zinc nitride (Zn₃N₂, z50, ϵ=1.6) and zirconium nitride (ZrN, z105, ϵ=1.4).

Preferred nitrides (NI) for use in the composition of the invention are nitrides of an element having an electronegativity of preferably at least 1.6, and more preferably at least 1.8 and/or of preferably at most 2.2.

Besides, the nitride (NI) is chosen preferably from nitrides of an element chosen from Groups IIIa, IVa, IVb, Va, Vb, VIa, VIb, VIIb and VIII of the Periodic Table of the Elements, and more preferably from nitrides of an element of Group IIIa of the Periodic Table of the Elements.

Particularly good results have been obtained when the nitride (NI) was boron nitride, which is the preferred nitride (NI).

Among the different crystalline forms of boron nitride, it is preferable to use hexagonal boron nitride in the composition according to this embodiment.

Generally, the average particle size of the nucleating agent, in particular of the nitride (NI), is advantageously equal to or below 30 μm, preferably equal to or below 20 μm, more preferably equal to or below 18 μm, more preferably equal to or below 10 μm, and/or is preferably equal to or at least 0.05 μm, equal to or at least 0.1 μm, more preferably equal to or at least 0.2 μm, equal to or at least 1 μm.

The average particle size of the nucleating agent, in particular of the nitride (NI), is preferably from 1 μm to 20 μm, more preferably from 2 μm to 18 μm, more preferably from 2 μm to 10 μm.

An average particle size of the nucleating agent, in particular of the nitride (NI), of about 2.5 μm gave particularly good results. In particular, a boron nitride having such average particle size has been found particularly effective.

The average particle size of the nucleating agent may be measured via light scattering techniques (dynamic or laser) using the respective equipment coming for example from the company Malvern (Mastersizer Micro or 3000) or using screen analysis according to DIN 53196.

When used, the total weight of the nucleating agent, in particular of the nitride (NI), in composition (C) is advantageously of at least about 0.1 wt. %, generally at least about 0.2 wt. %, preferably at least about 0.3 wt. %, more preferably at least about 0.5 wt. %, and/or of at most about 10 wt. %, preferably at most about 8 wt. %, more preferably at most about 5 wt. %, and even more preferably at most about 3 wt. %, based on the total weight of composition (C).

In some embodiments, composition (C) comprises at least one additive other than nucleating agent. Such additives include, but are not limited to, (i) colorants such as dyes (ii) pigments such as titanium dioxide, zinc sulfide and zinc oxide (iii) light stabilizers, e.g., UV stabilizers, (iv) heat stabilizers, (v) antioxidants such as organic phosphites and phosphonites, (vi) acid scavengers, (vii) processing aids, (viii) nucleating agents, (ix) internal lubricants and/or external lubricants, (x) flame retardants, (xi) smoke-suppressing agents, (x) anti-static agents, (xi) anti-blocking agents, (xii) conductivity additives such as carbon black and carbon nanofibrils, (xiii) plasticizers, (xiv) flow modifiers, (xv) extenders, (xvi) metal deactivators and (xvii) flow aids such as silica.

When an additional optional ingredient is present in composition (C), the total weight of the optional ingredient, based on the total weight of the composition (C), is advantageously equal to or above 0.1 wt. %, preferably equal to or above wt. 0.5%, more preferably equal to or above 1 wt. % and even more preferably more preferably equal to or above 2 wt. %, and/or equal to or below 30 wt. %, preferably below 20 wt. %, more preferably below 10 wt. % and even more preferably below 5 wt. %, based on the total weight of composition (C).

According to certain embodiments, composition (C) essentially consists of polymer (PEKK_{low}) and polymer (PEKK_{high}), as described above. For the purpose of the present invention, the expression “consisting essentially of” is to be understood to mean that any additional component different from those listed, is present in an amount of at most 1 wt. %, preferably at most 0.5 wt. %, based on the total weight of composition (C), so as not to substantially alter the properties of the composition.

According to other embodiments, composition (C) essentially consists of polymer (PEKK_{low}), polymer (PEKK_{high}), and nitride (NI), as described above.

According to still other embodiments, composition (C) essentially consists of polymer (PEKK_{low}), polymer (PEKK_{high}), and one or more than one additional ingredient other than nitride (NI), as listed above. According to these embodiments, the composition (C) may comprise nitride (NI), as described above.

### Methods for Making the Thermoplastic Polymer Matrix

The thermoplastic polymer matrix comprises composition (C). The thermoplastic polymer matrix essentially consists of, preferably consists of composition (C).

The polymer matrix can be prepared by a variety of methods involving intimate admixing of polymer (PEKK_{low}), polymer (PEKK_{high}), possibly with nucleating agent, such as for instance a nitride (NI), and/or with any optional additional ingredient, as detailed above, as desired in the formulation. For example dry (or powder) blending, suspension or slurry mixing, solution mixing, melt mixing or any combination thereof can be used. As used herein, the “other constituents” of the polymer matrix includes any other constituent which is desired in the polymer matrix on top of polymer (PEKK_{low}) and polymer (PEKK_{high}), including possibly the nucleating agent or any of additional optional ingredients listed above.

The polymer matrix may be prepared by a method comprising solubilizing polymer (PEKK_{low}) and polymer (PEKK_{high}), possibly in combination with other constituents, in a medium which is liquid at the temperature of the solubilization. Indeed, such solubilization may be accompanied by heating polymer (PEKK_{low}) and polymer (PEKK_{high}), in said liquid medium, which may advantageously comprise at least one of diphenylsulfone, benzophenone, 4-chlorophenol, 2-chlorophenol, and meta-cresol. A suitable liquid medium for effectively solubilizing polymer (PEKK_{low}) and polymer (PEKK_{high}), is diphenyl sulfone (DPS), which is liquid beyond 123° C., or blends of organic solvents comprising a major amount of DPS. When DPS is used, the mixing is achieved by heating at a temperature of at least 250° C., preferably at least 275° C., more preferably at least 300° C. Good results have been obtained when solubilizing polymer (PEKK_{low}) and polymer (PEKK_{high}) in DPS at a temperature of about 330° C.

The polymer matrix can be recovered from the liquid medium by standard techniques, including liquid/solid separations, crystallization, extraction, etc.

When DPS is used, the solubilized polymer (PEKK_{low}) and polymer (PEKK_{high}) in liquid DPS is cooled below melting temperature of DPS, so as to obtain a solid which, possibly after grinding, is extracted with a mixture of acetone and water, possibly rinsed with an aqueous medium, and finally dried.

As an alternative, the polymer matrix may be manufactured for example by melt mixing or a combination of powder blending and melt mixing. Powder blending is practicable when polymer (PEKK_{low}) and polymer (PEKK_{high}), and optionally the other constituents, are provided under the form of powders. Typically, the powder blending of polymer (PEKK_{low}) and polymer (PEKK_{high}), as above detailed, may be carried out by using high intensity mixers, such as notably Henschel-type mixers and ribbon mixers.

It is also possible to manufacture composition of the invention by melt compounding polymer (PEKK_{low}) and polymer (PEKK_{high}), and optionally the other constituents, and/or by further melt compounding the powder mixture as above described. Conventional melt compounding devices, such as co-rotating and counter-rotating extruders, single screw extruders, co-kneaders, disc-pack processors and various other types of extrusion equipment can be used. Preferably, extruders, more preferably twin screw extruders can be used.

If desired, the design of the compounding screw, e.g. flight pitch and width, clearance, length as well as operating conditions will be advantageously chosen so that sufficient heat and mechanical energy is provided to advantageously fully melt the powder mixture or the ingredients as above detailed and advantageously obtain a homogeneous distribution of the different ingredients. Provided that optimum mixing is achieved between the bulk polymer and filler contents, it is advantageously possible to obtain strand extrudates of the polymer matrix. Such strand extrudates can be chopped by means e.g. of a rotating cutting knife after some cooling time on a conveyer with water spray, so as to provide the polymer matrix the form of pellets or beads. The pellets or beads of the polymer matrix can then be further used for the fabrication of parts or composites, or may be ground to provide the polymer matrix in powder form for powder fabrication techniques.

### Fibers

As used herein, the term “fiber” has its ordinary meaning as known to those skilled in the art and may include one or more fibrous materials adapted for the reinforcement of composite structures, i.e., a “reinforcing fiber”. The term “fiber” is used herein to refer to fibers that have a length of at least 0.5 mm.

The fibers may be organic fibers, inorganic fibers or mixtures thereof. Suitable fibers for use as the reinforcing fiber component include, for example, carbon fibers, graphite fibers, glass fibers, such as E glass fibers, ceramic fibers such as silicon carbide fibers, synthetic polymer fibers such as aromatic polyamide fibers, polyimide fibers, high-modulus polyethylene (PE) fibers, polyester fibers and polybenzoxazole fibers such as poly-p-phenylene-benzobisoxazole (PBO) fibers, aramid fibers, boron fibers, basalt fibers, quartz fibers, alumina fibers, zirconia fibers and mixtures thereof. Fibers may be continuous or discontinuous and may be aligned or randomly oriented.

In an embodiment the composite material of the invention comprises continuous fibers. As referred to herein, “continuous fibers” refer to fibers having a length of greater than or equal to 3 millimeters (“mm”), more typically greater than or equal to 10 mm and an aspect ratio of greater than or equal to 500, more typically greater than or equal to 5000. As referred to herein, “aligned fibers” means that the majority of the fibers are substantially aligned parallel to one another. For example, in some embodiments, the fibers are aligned when the alignment of each fiber in the group at any one place along at least about 75% of its length (preferably at least about 80%, or even 85% of its length) does not deviate more than about 25 degrees (preferably not more than about 20 degrees, or even 15 degrees) from parallel to the immediately adjacent fibers.

In one embodiment, the fibers comprise carbon fibers, glass fibers, or both carbon fibers and glass fibers.

In some embodiments, the fibers include at least one carbon fiber. As used herein, the term “carbon fiber” is intended to include graphitized, partially graphitized, and ungraphitized carbon reinforcing fibers, as well as mixtures thereof. The carbon fibers can be obtained by heat treatment and pyrolysis of different polymer precursors such as, for example, rayon, polyacrylonitrile (PAN), aromatic polyamide or phenolic resin; carbon fibers may also be obtained from pitchy materials. The term “graphite fiber” is intended to denote carbon fibers obtained by high temperature pyrolysis (over 2000° C.) of carbon fibers, wherein the carbon atoms place in a way similar to the graphite structure. The carbon fibers are preferably chosen from the group consisting of PAN-based carbon fibers, pitch based carbon fibers, graphite fibers, and mixtures thereof.

It is noted that end uses requiring high-strength composite structures often employ fibers having a high tensile strength (e.g., 3500 MegaPascals or “MPa”) and/or a high tensile modulus (e.g., 200 GigaPascals or “GPa”). In one embodiment, therefore, the fibers comprise continuous carbon fibers, including, for example, carbon fibers that exhibit a tensile strength of greater than or equal to 3500 MPa and a tensile modulus of greater than or equal to 200 GPa. In one embodiment, the reinforcing fibers comprise continuous carbon fibers having a tensile strength of greater than or equal to 5000 MPa and a tensile modulus of greater than or equal to 250 GPa. In such embodiments, it is preferable that the carbon fibers are aligned, continuous carbon fibers exhibiting a tensile strength of greater than or equal to 3500 MPa and a tensile modulus of greater than or equal to 200 GPa.

The carbon fibers may be sized or un-sized. In one embodiment, the carbon fibers are sized carbon fiber. The appropriate size for a carbon fiber is a size that is thermally compatible with anticipated processing temperatures and may be selected from, for example, polyamideimide, polyetherimide, and polyimide polymers, each of which may optionally include additives, e.g., nucleating agents, to improve the interfacial properties of the fiber.

In some embodiments, the reinforcing fibers include at least one glass fiber. Glass fibers may have a circular cross-section or a non-circular cross-section (such as an oval or rectangular cross-section). When the glass fibers used have a circular cross-section, they preferably have an average glass fiber diameter of 3 to 30 μm, with a particularly preferred average glass fiber diameter of 5 to 12 μm. Different types of glass fibers with a circular cross-section are available on the market depending on the type of the glass they are made of. One may notably cite glass fibers made from E- or S-glass.

In some embodiments, the glass fiber is standard E-glass material with a non-circular cross section. In some embodiments, the polymer composition includes S glass fibers with a circular cross-section.

Fibers suitable for manufacturing the composite material of the invention may be included in the composite material in a number of different forms or configurations, which vary depending on the application of the targeted composite material. For example, the reinforcing fibers may be provided in the form of continuous fibers, sheets, plies, and combinations thereof. Continuous fibers may further adopt any of unidirectional, multi-dimensional, non-woven, woven, knitted, non-crimped, web, stitched, wound, and braided configurations, as well as swirl mat, felt mat, and chopped mat structures. The fiber tows may be held in position in such configurations by cross-tow stitches, weft-insertion knitting stitches, or a small amount of resin, such as a sizing. Fibers may also be included as one or multiple plies across all or a portion of the composite material, or in the form of pad-ups or ply drops, with localised increases/decreases in thickness. The areal weight of a single layer or cross section of such fibers can vary, for example, from 50 to 600 g/m².

In some embodiments, continuous fibers suitable for use in connection with the composite materials of the present invention may be in the form of rovings or tows (including individual tows or rovings, tow/roving bundles or spread tows). Rovings generally refer to a plurality of continuous untwisted filaments of fiber, e.g., glass fiber, optionally reinforced with a chemical binding material. Similarly, tows generally refer to a plurality of continuous individual filaments, e.g., carbon filaments, optionally with an organic coating. The size of the rovings or tows used herein is not particularly limited, but exemplary tows can include, e.g., aerospace-grade tow sizes, which typically range from 1 K to 24 K and commercial-grade tows, which typically range from 48 K to 320 K. The tows may be bundled or spread (e.g., untwisted) as required for the end use. For example, use of a spread tow can not only reduce the thickness of the tow, but can also reduce the incidence of gaps between individual tows in a composite material. This can lead to a weight savings in the composite laminate, while potentially achieving the same or better performance.

In some embodiments, the fibers may be discontinuous, e.g., aligned discontinuous fibers. Such discontinuous tows may have random lengths (e.g., created by random breakage of individual filaments) or may have roughly uniform lengths (e.g., created by cutting or separating individual filaments). Use of discontinuous fibers can allow individual fibers to shift position in relation to adjacent fibers, thus impacting the pliability of the material and potentially aiding in forming, draping, and stretching the fibers.

In some embodiments, fibers suitable for use in connection with the composite materials of the present invention may be in the form of unidirectional tapes. As used herein, “tape” means a strip of material with longitudinally extending fibers that are aligned along a single axis of the strip material. Tapes are advantageous because can be used in hand or automated layup processes in order to create a composite material having relatively complex shape. In one embodiment, the composite material comprises a unidirectional continuous-fiber reinforced tape.

In some embodiments, fibers suitable for use in connection with the composite materials of the present invention may be in the form of non-woven fabrics, such as mats. Non-woven fabrics include fibers (continuous or discontinuous) in a randomly-oriented arrangement. Because the fibers are randomly oriented, non-woven fabrics are generally isotropic, possessing substantially equal strength in all directions.

In still other embodiments, fibers suitable for use in connection with the composite materials of the present invention may be in the form of woven fabrics, which are typically woven on looms in a variety of weights, weaves and widths. Woven fabrics are generally bidirectional, providing good strength in the directions of fiber axial orientation (0°/90°). While woven fabrics can facilitate fast composite fabrication, the tensile strength may not be as high as, e.g., non-woven fabrics due to fiber crimping during the weaving process. In some embodiments, the woven fabric is in the form of a woven roving, where continuous fiber rovings are interlaced into fabrics. Such woven rovings may be thick and therefore used for heavy reinforcement, e.g., in hand layup operations and tooling applications. Optionally, such woven rovings may include fine fiberglass and, therefore, can be used for applications such as reinforcing printed circuit boards. Hybrid fabrics can also be constructed, using varying fiber types, strand compositions and fabric types.

In some embodiments, fibers suitable for use in connection with the composite materials of the present invention may be in the form of braided fabrics. Braided fabrics are generally obtained by interlacing three or more fibers (e.g., in the form of tows or rovings) in such a way that they cross one another and are laid together in diagonal formation, forming a narrow strip of flat or tubular fabric. Braided fabrics are generally continuously woven on the bias and have at least one axial yarn that is not crimped in the braiding process. Intertwining the fibers without twisting typically leads to a greater strength to weight ratio than found in woven fabrics. Braided fabrics, which can easily conform to various shapes, can be made in a sleeve-type format or in a flat fabric form. Flat braided fabrics can be produced with a triaxial architecture, having fibers oriented at 020 , +60° and −60° within a single layer, which can eliminate problems associated with layering of multiple 0°, +45°, −45° and 90° fabrics—including delamination. Because the fibers in the braided structure are interlocked, and therefore involved in a loading event, the load is evenly distributed throughout the structure. Therefore, braided fabrics can absorb a great deal of energy and exhibit very good impact resistance, damage tolerance and fatigue performance.

In some embodiments, the composite material of the invention is provided in the form of a substantially bidimensional material, e.g., material having one dimension (thickness or height) that is significantly smaller than the other two dimensions (width and length), such as sheets and tapes. In certain preferred embodiments, the composite material of the invention is selected from the group consisting of:
plies of impregnated fabrics, including but not limited to non-woven fabrics such as mats, multiaxial fabrics, woven fabrics or braided fabrics; and
unidirectional (continuous or discontinuous) fiber reinforced tapes or prepregs, preferably where the fibers are aligned.

According to certain embodiments, fibers are provided as a preform. Preforms are made by stacking and shaping layers of one or more of the above forms into a predetermined three-dimensional form. Preforms can be particularly desirable because complex part shapes can be approximated closely by careful selection of layers.

### Composite Materials

As used herein, the term “composite material” generally refers to an assembly of fibers and a polymer matrix material that is either impregnated, coated or laminated onto the fibers as described above. The composite material of the present invention includes a polymer matrix that comprises composition (C).

In some aspects, the composite materials of the present invention exhibit a superior combination of thermal and crystallization properties, e.g., versus composites comprising known PEKK polymers. In some embodiments, the composite materials of the present invention:

comprise a composition (C) having a melting temperature of less than or equal to 330° C., preferably from 295° C. to 328° C. and exhibit at least one mechanical property (e.g., open hole compression strength, in-plane shear modulus) which has a value of at least 90% of, or even at least 95% of, the corresponding mechanical property of a composite material of the same form, but comprising PEKK.

As used herein “a composite material of the same form” refers to a composite material having the same type of fibers (e.g., carbon fiber, glass fiber, etc.) in the same format (e.g., unidirectional, woven, nonwoven, etc.) and only differing in its polymer matrix.

In some embodiments, the composite materials of the present invention comprise a composition (C) having a melting temperature of less than or equal to 330° C., preferably from 295° C. to 328° C. and exhibit at least one of:
an open hole compression strength greater than or equal to 320 MPa, an and even more typically greater than or equal to 322 MPa), as measured in accordance with ASTM D6484,
an in-plane shear modulus of greater than or equal to 4.7 GPa, more typically greater than or equal to 4.8 GPa, as measured in accordance with ASTM D3518.

In such embodiments, the composite material can be, e.g., unidirectional tape which comprises intermediate modulus carbon fibers and composition (C) defined herein.

For example, in one embodiment, composition (C) has a melt temperature of less than or equal to 330° C., more typically of from 295° C. to 328° C., and the composite material exhibits an in-plane shear modulus of greater than or equal to 4.7 GPa, more typically greater than or equal to 4.8 GPa, as measured in accordance with ASTM D3518. In such embodiments, the composite material can be, e.g., unidirectional tape which comprises intermediate modulus carbon fibers and composition (C) defined herein.

For example, in one embodiment, composition (C) has a melt temperature of less than or equal to 330° C., more typically of from 295° C. to 328° C., and the composite material exhibits an open hole compression strength greater than or equal to 320 MPa, an and even more typically greater than or equal to 322 MPa), as measured in accordance with ASTM D6484. In such embodiments, the composite material can be, e.g., unidirectional tape which comprises intermediate modulus carbon fibers and composition (C) defined herein.

The composite material of the invention preferably comprises from 20 to 80 wt. % of fibers and from 80 to 20 wt. % of the polymer matrix comprising composition (C), based on the weight of the composite material.

In one embodiment, the composite material comprises from 30 to 80, e.g., from 50 to 80, more typically 55 to 75 wt. % of continuous carbon fibers and 20 to 70, more typically 25 to 45 wt. % of a polymer matrix that comprises composition (C). In one embodiment of the composite material, the fibers are continuous carbon fibers that are substantially aligned along a single axis and the composite material is in the form of a unidirectional carbon fiber reinforced resin matrix tape that comprises from 50 to 80 wt. % of carbon fiber and from 20 to 50 wt. % of a polymer matrix that comprises composition (C). In one embodiment of the composite material, the continuous carbon fibers are in the form of a woven or non-woven fabric and the composite material comprises from 45 to 70 wt. % of continuous carbon fiber and from 30 to 55 wt. % of a polymer matrix that comprises composition (C).

In one embodiment, the composite material comprises from 30 to 80, more typically 50 to 75 wt. % of continuous glass fibers and 20 to 70, more typically 25 to 45 wt. % of composition (C). In one embodiment of the composite material, the fibers are continuous glass fibers that are substantially aligned along a single axis and the composite material in the form of a unidirectional glass fiber reinforced resin matrix tape that comprises from 65 to 80 wt. % glass fibers and from 20 to 35 wt. % of a polymer matrix that comprises composition (C). In one embodiment the composite material, the continuous fibers are glass fibers in the form of a woven or non-woven glass fabric and the composite material comprises from 50 to 70 wt. % glass fibers and from 30 to 50 wt. % of a polymer matrix that comprises composition (C).

In one embodiment, the composite material has a fiber areal weight of from 50 to 400 grams per square meter. For unidirectional tape, the composite material has a typical fiber areal weight of from 130 to 200 grams per square meter. For fabric, the composite material has a typical fiber areal weight of from 170 to 400 grams per square meter.

The composite material of the invention may be a single layer material, consisting of fibers and a polymer matrix that comprises composition (C).

The composite material may alternatively comprise more than one layer.

A further object of the invention is thus a multilayer composite assembly comprising a first layer consisting of the composite material, that is a composite material consisting of fibers and a polymer matrix that comprises composition (C), and at least one layer comprising a thermoplastic polymer composition [composition (TP)] in contact with at least one surface of the composite material.

Composition (TP) is generally chosen such that it has a lower melting point and processing temperature than the polymer matrix comprising composition (C). In certain embodiments, the melting and/or processing temperature of composition (TP) is 10° C. to 20° C. less than the melting and/or processing temperature of the high performance polymer. Composition (TP) is free of fibers.

Composition (TP) may suitably comprise polymers chosen from polyaryletherketones (PAEK), polyetherimide (PEI), polyimides, PAEK co-polymer with PEI and/or polyarylethersulfone (PAES) and/or polyphenylenesulfide (PPS), and PAEK blends with one or more of PEI, PAES, PPS and/or polyimides.

### Methods of Making Composite Material

Various methods can be employed by which fibers may be impregnated with the polymer matrix comprising composition (C), wherein the matrix is either in molten or particulate form, including, for example, powder coating, film lamination, extrusion, pultrusion, aqueous slurry, and melt impregnation, to form plies in the form of, for example, sheets or tapes of fibers that are at least partially impregnated with the polymer matrix.

In one embodiment the composite material comprises a unidirectional continuous fiber reinforced tape made by a melt impregnation process. Melt impregnation process generally comprises drawing a plurality of continuous filaments through a melted precursor composition that comprises polymer matrix. The precursor composition may additionally comprise specific ingredients such as plasticizers and processing aids, which facilitate impregnation. Melt impregnation processes include direct melt and aromatic polymer composite (“APC”) processes, such as, for example, as described in EP 102158.

In one embodiment the composite material comprises a unidirectional continuous fiber reinforced tape made by a slurry process. An exemplary slurry process can be found, for example, in U.S. Pat. No. 4,792,481 (O'Connor, et al).

In one embodiment, the composite material comprises either a unidirectional continuous fiber reinforced tape or woven/non-woven fiber reinforcement (e.g., fabric) made by a film lamination process either through a series of heated and chilled rolls or a double belt press. Film lamination processes generally include disposing at least one layer of fibrous material on or between at least one layer of polymer matrix (e.g., a polymer matrix film) to form a layered structure, and passing the layered structure through the series of heated and chilled rolls or through the double belt press.

In one embodiment, the composite material comprises either a unidirectional continuous fiber reinforced tape or woven/non woven fiber reinforcement (e.g., fabric) made by a dry powder coating/fusion process where dry powder is deposited uniformly on the fibers or fiber web (e.g., fabric) and subsequently heat is applied to fuse the powder to the fibers or fiber web (e.g., fabric).

The composite material of the invention may be in the form of plies of matrix impregnated fibers. A plurality of plies may be placed adjacent one another to form an unconsolidated composite laminate, such as a prepreg. The fiber reinforced layers of the laminate may be positioned with their respective fiber reinforcements in selected orientations relative to one another.

Composite laminates may be manufactured by depositing, or “laying up” layers of composite material on a mold, mandrel, tool or other surface. This process is repeated several times to build up the layers of the final composite laminate.

The plies may be stacked, manually or automatically, e.g., by automated tape layup using “pick and place” robotics, or advanced fiber placement wherein pre-impregnated tows of fibers are heated and compacted in a mold or on a mandrel, to form a composite laminate having desired physical dimensions and fiber orientations.

The layers of an unconsolidated laminate are typically not completely fused together and the unconsolidated composite laminate may exhibit a significant void content, e.g., greater than 20% by volume as measured by X-ray microtomography. Heat and/or pressure may be applied, or sonic vibration welding may be used, to stabilize the laminate and prevent the layers from moving relative to one another, e.g., to form a composite material “blank”, as an intermediate step to allow handling of the composite laminate prior to consolidation of the composite laminate.

The composite laminate so formed is subsequently consolidated, typically by subjecting the composite laminate to heat and pressure, e.g., in a mold, to form a shaped fiber reinforced thermoplastic matrix composite article. If necessary, a tie layer made from composition (C) may be used for adhering layers of the unconsolidated laminate. Such tie-layer may be provided as a self-supported film made of composition (C) or may be provided under the form of a coating, which is coated onto at least one of the surfaces of the layers of the unconsolidated composite laminate to be assembled and consolidated.

As used herein, “consolidation” is a process by which the matrix material is softened, the layers of the composite laminate are pressed together, air, moisture, solvents, and other volatiles are pressed out of the laminate, and the adjacent plies of the composite laminate are fused together to form a solid, coherent article. Ideally, the consolidated composite article exhibits minimal, e.g., less than 5% by volume, more typically less than 2% by volume, void content as measured by X-ray microtomography.

In one embodiment, the composite material is consolidated in a vacuum bag process in an autoclave or oven. In one embodiment, the composite material is consolidated in vacuum bag process under a vacuum of greater than 600 mm Hg by heating to a consolidation temperature of greater than 320° C., more typically from 330° C. to 360° C., and once consolidation temperature is reached, pressure, typically from 0 to 20 bars, is applied for a time, typically from 1 minute to 240 minutes and then allowed to cool. Overall cycle time, including heating, compression, and cooling, is typically within 8 hours or less, depending on the size of the part and the performance of the autoclave.

In one embodiment, the composite material is laminated by an automated lay-up machine (ATL, AFP or filament wind) outfitted with a heat device to simultaneously melt and fuse the layer to the previous laid layer as it is being placed and oriented on the previous laid layer to form a low void, consolidated laminate (<2% volume of voids). This low void consolidated laminate can be used “as is” or subsequently annealed in either a free standing or vacuum bag operation typically in temperature range of 170° C. to 270° C. for a time from 1 minute to 240 minutes.

In one embodiment, the fully impregnated composite prepreg material plies are laminated by an automated lay-up machine outfitted with a heat device to simultaneously melt and fuse the layer to the previous layer as it is being placed and oriented on the previous laid layer to form a preform with a void content >2%. The preform is then subsequently consolidated in either a “vacuum bag process” as described earlier, compression mold, stamp form, or continuous compression molding process.

In one embodiment, the fully impregnated composite prepreg material plies are pre-oriented and consolidated in a heated and cooled press, double belt press or continuous compression molding machine to make a consolidated laminate that can be cut to size to be a forming blank in a stamp forming process where tool temperature range from 10° C. to 270° C. and the forming blank is heated rapidly to the melt processing temperature of 320° C. to 360° C. before shaping and consolidating the molten blank in the tool. The resulting part can be used “as is” or in a subsequent step of placing said formed part in an injection molding tool to rapidly heat the laminate to an intermediate temperature to inject a higher melt processing temperature PAEK polymer such as PEEK in neat or filled form to make a complex shaped hybrid part.

The composite materials of the invention may be used in any of the end use applications where composites are conventionally employed or have been proposed to be employed. Representative applications include composites and laminates (including two- and three dimensional panels and sheets) for aerospace/aircraft, automobiles and other vehicles, boats, machinery, heavy equipment, storage tanks, pipes, sports equipment, tools, biomedical devices (including devices to be implanted into the human body), building components, wind blades and the like.

Should the disclosure of any patents, patent applications, and publications which are incorporated herein by reference conflict with the description of the present application to the extent that it may render a term unclear, the present description shall take precedence.

### EXAMPLES

The disclosure will be now described in more detail with reference to the following examples, whose purpose is merely illustrative and not intended to limit the scope of the disclosure.

### Raw Materials for Polymer Synthesis

1,2-dichlorobenzene, terephthaloyl chloride, isophthaloyl chloride, 3,5-dichlorobenzoylchloride, aluminum chloride (AlCl₃), methanol were purchased from Sigma Aldrich.

1,4-Bis(4-phenoxybenzoyl)benzene was prepared according to IN patent 193687 (filed on Jun. 21, 1999 and incorporated herein by reference).

Diphenyl sulfone (polymer grade) was procured from Proviron (99.8% pure).

Sodium carbonate, light soda ash, was procured from Solvay S.A., France and dried before use. Its particle size was such that its d₉₀ was 130 μm.

Potassium carbonate with a d₉₀<45 μm was procured from Armand products and dried before use.

Lithium chloride (anhydrous powder) was procured from Acros.

NaH₂PO₄.2H₂O and Na₂HPO₄ were purchased from Sigma-Aldrich.

1,4-bis(4′-fluorobenzoyl)benzene (1,4-DFDK) and 1,3 bis(4′-fluorobenzoyl)benzene (1,3-DFDK) were prepared by Friedel-Crafts acylation of fluorobenzene according to Example 1 of U.S. Pat. No. 5,300,693 to Gilb et al. (filed Nov. 25, 1992 and incorporated herein by reference in its entirety). Some of the 1,4-DFDK was purified as described in U.S. Pat. No. 5,300,693 by recrystallization in chlorobenzene, and some of the 1,4-DFDK was purified by recrystallization in DMSO/ethanol. The 1,4-DFDK purified by recrystallization in DMSO/ethanol was used as the 1,4-DFDK in the polymerization reactions to make PEKK described below, while 1,4-DFDK recrystallized in chlorobenzene was used as precursor for 1,4-bis(4′-hydroxybenzoyl)benzene (1,4-BHBB).

1,4-BHBB and 1,3-bis(4′-hydroxybenzoyl)benzene (1,3-BHBB) were produced by hydrolysis of the 1,4-DFDK, and 1,3-DFDK, respectively, following the procedure described in Example 1 of U.S. Pat. No. 5,250,738 to Hackenbruch et al. (filed Feb. 24, 1992 and incorporated herein by reference in its entirety). They were purified by recrystallization in DMF/ethanol.

### Determination of the Melt Flow Index

The melt flow index was determined according to ASTM D1238 at the indicated temperature (340 to 380° C. depending on the melting temperature of the material) with a 3.8 kg weight. The final MFI for a 8.4 kg weight was obtained by multiplying the value obtained by 2.35.

### Determination of the Glass Transition Temperature, Melting Temperature and Heat of Fusion

The glass transition temperature T_{g} (mid-point, using the half-height method) and the melting temperature Tₘ were determined on the 2^{nd} heat scan in differential scanning calorimeter (DSC) according to ASTM D3418-03, E1356-03, E793-06, E794-06, further according to the details below. Detailed procedure as used in this invention is as follows: a TA Instruments DSC Q20 was used with nitrogen as carrier gas (99.998% purity, 50 mL/min). Temperature and heat flow calibrations were done using indium. Sample size was 5 to 7 mg. Hermetically sealed pans were used. The weight was recorded ±0.01 mg. The heat cycles were: 1^{st} heat scan: 30.00° C. to 400.00° C. at 20.00° C./min, isothermal at 400.00° C. for 1 min; 1^{st} cool scan: 400.00° C. to 30.00° C. at 20.00° C./min, isothermal for 1 min; 2′ heat scan: 30.00° C. to 400.00° C. at 20.00° C./min, isothermal at 400.00° C. for 1 min.

The melting temperature Tₘ was determined as the peak temperature of the melting endotherm on the 2^{nd} heat scan. The enthalpy of fusion was determined on the 2^{nd} heat scan and was taken as the area over a linear baseline drawn from above the T_{g} to a temperature above end of the endotherm peak. The crystallization temperature T_{c} was determined as the peak temperature of the crystallization exotherm on the 1^{st} cool scan. The possible presence of a cold crystallization was determined from 2^{nd} heat scan: the presence of an exotherm before on-set of endothermic melting peak was positively confirmed when an exotherm heat flow exceeding 0.5 J/g was spotted.

### Determination of Elemental Impurities Such as Aluminum in Polymer Composition By ICP-OES

A clean, dry platinum crucible was placed onto an analytical balance, and the balance was zeroed. One half to 3 grams of polymer sample was weighed into a boat and its weight was recorded to 0.0001 g. The crucible with sample was placed in a muffle furnace (Thermo Scientific Thermolyne F6000 Programmable Furnace). The furnace was gradually heated to 525° C. and held at that temperature for 10 hours to dry ash the sample. Following ashing, the furnace was cooled down to room temperature, and the crucible was taken out of the furnace and placed in a fume hood. The ash was dissolved in diluted hydrochloric acid. The solution was transferred to a 25 mL volumetric flask, using a polyethylene pipette. The crucible was rinsed twice with approximately 5 mL of ultrapure water (R<18 M Ωcm) and the washes were added to a volumetric flask to effect a quantitative transfer. Ultrapure water was added to total 25 mL in the flask. A stopper was put on the top of the flask and the contents were shaken well to mix.

ICP-OES analysis was performed using an inductively-coupled plasma emission spectrometer Perkin-Elmer Optima 8300 dual view. The spectrometer was calibrated using a set of NIST traceable multi-element mixed standards with analyte concentrations between 0.0 and 10.0 mg/L. A linear calibration curve was obtained in a range of concentrations with a correlation coefficient better than 0.9999 for each of 48 analytes. The standards were run before and after every ten samples to ensure instrument stability. The results were reported as an average of three replicates. The concentration of elemental impurities in the sample was calculated with the following equation: A=(B*C)/(D) where:
A=concentration of element in the sample in mg/kg (=wt.ppm)
B=element in the solution analyzed by ICP-OES in mg/L
C=volume of the solution analyzed by ICP-OES in mL
D=sample weight in grams used in the procedure.

### Determination of Fluorine Concentration in Polymers by Combustion Ion Chromatography Method

For combustion ion chromatography (IC) analysis a clean, pre-baked, dry ceramic sample boat was placed onto an analytical balance, and the balance was zeroed. Approximately 20 mg of polymer sample was weighed into the boat and weight was recorded to 0.0001 g. The boat with sample was placed in the combustion furnace set with an inlet temperature of 900° C. and an outlet temperature of 1000° C. The combusted sample and argon carrier gas is passed through 18.2 MO ultrapure water, and injected autonomously into an IC system equipped with a conductivity detector.

Combustion IC analysis was performed using a Dionex ICS 2100 IC system, equipped with a Dionex IonPac AS19 IC column and guard column (or equivalent), Dionex CRD 200 4 mm suppressor set at 50 mA, as well as a, GA-210 gas absorption unit HF-210 furnace, and ABC-210 boat controller, all from Mitsubishi Analytech.

The elution gradient for the method is as follows:
0-10 minutes: 10 mM KOH
10-15 minutes: steady, constant increase to 20 mM KOH
15-30 minutes: 20 mM KOH

The instrument was calibrated using a 3-point calibration from a NIST traceable 7-anion mixture supplied by AIITech with analyte concentration between 0.1-3.0 mg/L for F⁻. A linear calibration curve was obtained in a whole range of concentrations with a correlation coefficient better than 0.9999 for each analyte. A control sample is run to verify the machine is operating correctly before any samples are analyzed. The concentration of anions in the sample was calculated with the following equation:
A=(B*C)/(D) where:
   A=concentration of element in the sample in mg/kg
   B=anion in the solution analyzed by IC in mg/L
   C=volume of the solution analyzed by IC in mL
   D=sample weight in mg used in the procedure.

### Preparative Example 1: Synthesis of Nucleophilic PEKK Having T/I Ratio=71/29 (PEKK_{high})

In a 500 mL 4-neck reaction flask fitted with a stirrer, a N₂ inlet tube, a Claisen adapter with a thermocouple plunging in the reaction medium, and a Dean-Stark trap with a condenser and a dry ice trap were introduced 112.50 g of diphenyl sulfone (DPS), 23.054 g of 1,3-BHBB, 16.695 g of 1,4-BHBB and 41.292 g of 1,4-DFDK. The flask content was evacuated under vacuum and then filled with high purity nitrogen (containing less than 10 ppm O₂). The reaction mixture was then placed under a constant nitrogen purge (60 mL/min). The reaction mixture was heated slowly to 270° C. At 270° C., 13.725 g of Na₂CO₃ and 0.078 g of K₂CO₃ was added via a powder dispenser to the reaction mixture over 60 minutes. At the end of the addition, the reaction mixture was heated to 310° C. at 1° C./minute. After 2 minutes at 310° C., 1.107 g of 1,4-DFDK were added to the reaction mixture while keeping a nitrogen purge on the reactor. After 5 minutes, 0.741 g of lithium chloride were added to the reaction mixture. 10 minutes later, another 0.402 g of 1,4-DFDK were added to the reactor and the reaction mixture was kept at temperature for 15 minutes. Another charge of 15 g of diphenyl sulfone was added to the reaction mixture, which was kept under agitation for 15 minutes.

The reactor content was then poured from the reactor into a stainless steel pan and cooled. The solid was broken up and ground in an attrition mill through a 2 mm screen. Diphenyl sulfone and salts were extracted from the mixture with acetone and water at pH between 1 and 12. 0.67 g of NaH₂PO₄.2H₂O and 0.62 g of Na₂HPO₄ were dissolved in 1200 mL DI water for the last wash. The powder was then removed from the reactor and dried at 120° C. under vacuum for 12 hours yielding 72 g of a yellow powder.

### Preparative Example 2: Synthesis of Nucleophilic PEKK Having T/I ratio=58/42 (PEKK_{low})

The same procedure as Example 1 was followed but with the amounts of reagents indicated in the Table 1 below.

TABLE 1

Example

| Reagent | | Ex. 1 | Ex. 2 |
|---|---|---|---|
| T/I | | 71/29 | 58/42 |
| DPS | g | 112.50 | 112.50 |
| 1,3-BHBB | g | 23.054 | 33.389 |
| 1,4-BHBB | g | 16.695 | 6.360 |
| 1,4-DFDK | g | 41.292 | 41.292 |
| Na₂CO₃ | g | 13.725 | 13.725 |
| K₂CO₃ | g | 0.078 | 0.078 |
| 1,4-DFDK | g | 1.107 | 1.006 |
| LiCl | g | 0.741 | 0.529 |
| 1,4-DFDK | g | 0.402 | 0.402 |
| DPS | g | 15 | 25 |
| MFI | g/10 min | 90 | 100 |
| MFI T | ° C. | 360 | 340 |
| Al content | ppm | <10 | <10 |
| F content | ppm | >100 | >100 |
| Td(1%) | ° C. | 535 | >520 |

### Preparative Example 3 : Preparation of electrophilic PEKK (e-PEKK) with T/I=72/28

In a 2000 mL 4-neck reaction flask fitted with a stirrer, a dry N₂ inlet tube, a thermocouple plunging in the reaction medium, and a condenser were introduced 1000 g 1,2-dichlorobenzene and 40.63 g 1,4-Bis(4-phenoxybenzoyl)benzene. Under a sweep of dry nitrogen, 7.539 g of terephthaloyl chloride, 9.716 g of isophthaloyl chloride and 0.238 g of benzoyl chloride were then added to the reaction mixture. The reactor was then cooled to −5° C. and 71.88 g of aluminium chloride (AICl₃) were added slowly while keeping the temperature below 5° C. The reaction was held at 5° C. for 10 minutes then the temperature of the mixture was increased to 90° C. at 5° C./minute. The reaction mixture was held at 90° C. for 30 minutes then cooled down to 30° C. At 30° C., 250 g of methanol were added slowly to maintain the temperature below 60° C. After the end of the addition, the reaction mixture was kept under agitation for 2 hours then cooled down to 30° C. The solid was then removed by filtration on a Büchner. The wet cake was rinsed on the filter with an additional 188 g of methanol. The wet cake was then re-slurried in a beaker with 440 g of methanol for 2 hours. The polymer solid was filtered again on Büchnerfunnel and the wet cake was rinsed on the filter with 188 g of methanol. The solid was slurried with 470 g of an aqueous hydrochloric acid solution (3.5 wt %) for 2 hours. The solid was then removed by filtration on a Büchner. The wet cake was rinsed on the filter with an additional 280 g of water. The wet cake was then re-slurried in a beaker with 250 g of 0.5N sodium hydroxide aqueous solution for 2 hours. The wet cake was then re-slurried in a beaker with 475 g of water and filtered on Büchnerfunnel. The last water washing step was repeated 3 more times. The polymer is then slurried with 0.75 g of an aqueous solution containing 6.6 wt % of NaH₂PO₄.2H₂O and 3.3 wt % of Na₂HPO₄ then dried in a vacuum oven at 180° C. for 12 hours. The melt flow index (360° C., 8.4 kg) was 82.g/10 min.

### Example 4: Preparation of Compositions by Melt Blending

The PEKK polymers of Examples 1 and 2 were melt-blended in a (PEKK_{high}/PEKK_{low}) ratio of 15/85 wt/wt using a Leistritz 18 mm twin-screw co-rotating intermeshing extruder having a length to diameter ratio (L/D) of 30. The ingredients which were all in either powder or pellet form, were in each case first tumble blended. The tumble-blending was done for about 20 minutes, followed by melt compounding using the above described extruder. The extruder had 6 barrel sections with barrel sections 2 through 6 being heated. Vacuum venting with a vacuum level of >25 in Hg was applied at barrel section 5 during compounding to strip off moisture and any possible residual volatiles from the compound. The extrudate was in each case stranded on a conveyor belt, air cooled, and fed to a pelletizer which cut it into pellets approximately 3 mm in diameter and 3 mm in length. Other compounding conditions were as follows: barrel sections 2-6 as well as the die section were heated to 360° C. The extruder was operated at a screw speed of about 200 rpm and the throughput rate was about 2.7 kg/hr.

The thermal properties of the PEKK polymers of Examples 1 to 3 and of the inventive composition of Example 4 are reported in Table 2.

TABLE 2

Example

| Components | EX 1 | EX 2 | EX 3 | EX 4 |
|---|---|---|---|---|
| PEKK_{high} | 100.0 | — | 100.0 | 15.0 |
| PEKK_{low} | — | 100.0 | — | 85.0 |
| T_{g} (° C.) | 162 | 159 | 152 | 159 |
| Tₘ (° C.) | 343 | 296 | 332 | 317 |
| T_{c} (° C.) | 280 | 221 | 272 | 250 |
| ΔH_{f} (J/g) | 46 | 20 | 40 | 31 |
| Cold Cryst. on 2^{nd} Heat? | N | Y | N | N |
| Meets Eq. 1 Criterion? | N | Y | Y | Y |
| Tₘ < 330° C.? | N | Y | N | Y |

The data in Table 2 show that the PEKK composition of Example 4 is endowed with a high T_{C} and a heat of fusion ΔHf exceeding 25 J/g, i.e. acceptably high crystallinity. Consequently, the composition of Example 4 provides a balance of properties: good processing (as evidenced by Tm lower than 330° C.) combined with fast crystallization rate (as evidenced by the high T_{c}) and suitable final crystalline fraction (as evidenced by ΔHf).

### Example 5 and Comparative Example 1: Composite Materials

Hextow IM8 carbon fibers (12K filaments, unsized; Nominal fiber strength=6067 MPa; Nominal Fiber Modulus=310 GPa) were impregnated with the composition of Example 4, to obtain a tape hereinafter identified as Example 5, and PEKK from example 3, to obtain a tape hereinafter identified as Comparative Example 1, by a melt impregnation process.

The resulting tapes had widths of 305 mm, fiber areal weights of 145±5 grams/m², and resin content weight percentage of 34±3 wt %. The tapes were then cut and laid up into the following test laminate lay-ups:

| Test | Test Method | Lay-up | | # Plies |
|---|---|---|---|---|
| In-Plane Shear Modulus | ASTM D3518 | [+45/−45]2 | s | 8 |
| Open Hole | ASTM D6484 | [+45/0/−45/90]3 | s | 24 |
| Compression Strength | | | | |

The lay-ups were vacuum bagged and then autoclaved using a straight ramp heating and cooling cycle while applying 635-735 mm Hg vacuum. The heat up ramp rate from 23° C. to the maximum process temperature was 3-5° C./min while the cooling rate was 5-7° C./min from the maximum temperature back to room temperature ambient (23° C.). When the temperature reached the maximum temperature then 0.68 MPa of pressure were applied and was held on the lay-up until after the panels had been consolidated and then cooled below 100° C. The maximum temperature for the two materials in the following table:

| | Maximum | | | Applied |
|---|---|---|---|---|
| | Temperature, | Heating Rate, | Cooling Rate, | Pressure |
| Material | ° C. | ° C./min | ° C./min | (MPa) |
| C. Ex. 1 | 375 | 3-5 | 5-7 | 0.68 |
| Ex. 5 | 355 | 3-5 | 5-7 | 0.68 |

The test laminates were C-scanned to ensure low porosity and then machined into test coupons. The test laminates were tested at 23° C. ambient conditions. The summary of the tests is summarized in Table 3.

TABLE 3

| Tests | Units | Comp. Example 1 | Example 4 |
|---|---|---|---|
| In-plane shear modulus | GPa | 4.86 ± 0.04 | 4.96 ± 0.35 |
| Open hole | MPa | 334 ± 8 | 328 ± 5 |
| Compression Strength | | | |

The data in Table 3 clearly shows that the composite material of Example 5 is within experimental error of the reference material of Comp. Example 1 both for in-plane shear modulus and open-hole compression strength which are matrix dominated properties. Thus, the inventive composite of Example 5 can achieve similar performance to the a reference composite material even though it was molded at 20° C. lower temperature.

1. A composite material, comprising:
fibers, and
a thermoplastic polymer matrix comprising a composition [composition (C)] comprising a first and a second PEKK polymer each PEKK polymer characterised by a T/I ratio, wherein the T/I ratio of the first PEKK polymer is different from T/I ratio of the second PEKK polymer.

2. The composite material of claim 1 in which composition (C) comprises a first PEKK polymer [(PEKK_{low})] having a T/I ratio [(T/I)_{low}], and a second PEKK polymer [(PEKK_{high})], having T/I ratio [(T/I)_{high}], such that (T/I)_{low}<(T/I)_{high}.

3. The composite material of claim 1 wherein each PEKK polymer is a polymer comprising recurring units (R^{T}) and recurring units (R^{I}), wherein recurring unit (R^{T}) is represented by formula (T): 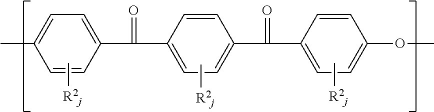
and recurring unit (R^{I}) is represented by formula (I): 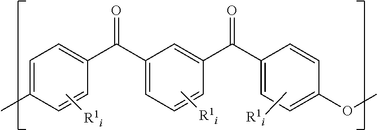
wherein:
each R¹ and R², at each instance, is independently selected from the group consisting of an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
each i and j, at each instance, are integers independently selected from 0 to 4; and the T/I ratio is defined as:
$$( T / I ) = \frac{T}{I} wherein :$$
$$T ( mol . \% ) = \frac{[ units ( {R}^{T} ) ]}{[ units ( {R}^{T} ) ] + [ units ( {R}^{I} ) ]} \times 100 ,$$
$$and I ( mol . \% ) = \frac{[ units ( {R}^{I} ) ]}{[ units ( {R}^{T} ) ] + [ units ( {R}^{I} ) ]} \times 100.$$

4. The composite material of claim 3 wherein (PEKK_{high}) has a molar content of units (R^{T}), (T_{high}), and (PEKK_{low}) has a molar content of units (R^{T}), (T_{low}), such that T_{high}−T_{low}≤20 mol. %.

5. The composite material of claim 2 wherein (T/I)_{low} is at least 50/50, and/or at most 64/36.

6. The composite material of claim 2 wherein (T/I)_{high} is at least 65/35, and/or at most 85/15.

7. The composite material of claim 2 wherein the weight ratio between polymer (PEKK_{low}) and polymer (PEKK_{high}) is of at least 60/40, and/or it is of at most 99/1.

8. The composite material of claim 2 wherein polymer (PEKK_{low}) and/or polymer (PEKK_{high}) is a nucleophilic PEKK polymer.

9. The composite material of claim 1 wherein composition (C) is characterized by one or more of the features selected from the group consisting of:
a crystallization temperature (Tc in C°), determined on second DSC heat scan, higher than the crystallization temperature of a PEKK polymer having the same melting temperature (Tₘ in) C°) determined on second DSC heat scan;
a melting temperature (Tₘ) of less than or equal to 330° C., a heat of fusion (ΔHf) exceeding 25 J/g; and no crystallization peak upon heating, on second DSC heat scan (“cold crystallization peak”);
a relation between melting temperature (Tₘ in ° C.) determined on second DSC heat scan, and crystallization temperature (T_{c} in ° C.) determined on first DSC cooling scan, which satisfies the following inequality: T_{c}≥1.3716×Tₘ−190° C.;
wherein Tₘ, T_{c}, ΔHf and the absence of cold crystallization peak are measured by differential scanning calorimetry (DSC) according to ASTM D3418-03, E1356-03, E793-06, E794-06, standard, applying heating and cooling rates of 20° C./min, with a sweep from 300° C. to 400° C.

10. The composite material of claim 1 wherein composition (C) further comprises at least one nucleating agent.

11. The composite material of claim 1 wherein composition (C) has a melting temperature (Tm) of less than or equal to 330° C.

12. The composite material of claim 1 wherein the fiber is a continuous fiber and/or is selected from the group consisting of carbon fibers, graphite fibers, glass fibers, ceramic fibers, synthetic polymer fibers, polyimide fibers, high-modulus polyethylene (PE) fibers, polyester fibers and polybenzoxazole fibers, aramid fibers, boron fibers, basalt fibers, quartz fibers, alumina fibers, zirconia fibers and mixtures thereof.

13. The composite material of claim 1 exhibiting at least one of:
an open hole compression strength greater than or equal to 320 MPa, as measured in accordance with ASTM D6484; and
an in-plane shear modulus of greater than or equal to 4.7 GPa, as measured in accordance with ASTM D3518.

14. A multilayer composite assembly comprising a first layer consisting of the composite material of claim 1 and at least one layer comprising a thermoplastic polymer composition [composition (TP)] in contact with at least one surface of the composite material.

15. A method of making the composite material of claim 1, the method comprising contacting the polymer matrix comprising composition (C) with at least a part of the surface of the fibers.

16. The method of claim 15, wherein the polymer matrix is contacted with fibers in a melt impregnation process, in slurry process, in a film lamination process or in dry powder coating/fusion process.

17. A method for making a low void, consolidated laminate, the method comprising:
processing layers of the composite material of claim 1 with an automated lay-up machine outfitted with a heat device to simultaneously melt and fuse a layer to a previously-laid layer as the layer is being placed and oriented on the previously-laid layer to form a consolidated laminate having less than 2% volume of voids; and
optionally further comprising annealing the consolidated laminate in either a free standing or vacuum bag operation, typically in temperature range of 170° C. to 270° C. for a time from 1 minute to 240 minutes.

18. A method for forming a composite part, the method comprising:
pre-orienting plies of the composite material of claim 1,
consolidating the pre-oriented plies in a heated and cooled press, double belt press or continuous compression molding machine to make a consolidated laminate;
optionally cutting the consolidated laminate to a pre-determined size to make a forming blank;
rapidly heating the forming blank to a temperature of 320 to 360 C in a stamp-forming process tool, thus making a formed composite part.

19. A consolidated laminate, composite part, article comprising a composite material of claim 1.
